(19) United States
(12) Patent Application Publication
(10) Pub. No.: US 2009/0037297 A1
(43) Pub. Date: Feb. 5, 2009

(54) COST AND CONTRIBUTION SALES CALCULATOR AND METHOD

(75) Inventors: Steven R. DIXEL, Arlington, VA (US); John C. Manzolillo, Baltimore, MD (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: United States Postal Service, Washington, DC (US)

(21) Appl. No.: 12/194,679

(22) Filed: Aug. 20, 2008

Related U.S. Application Data
(62) Division of application No. 10/923,206, filed on Aug. 20, 2004.

(51) Int. Cl. G06Q 30/00; G06Q 40/00; G06F 17/30

(52) U.S. Cl. 705/27; 705/26; 705/40; 705/35

(57) ABSTRACT

Embodiments consistent with the invention include a system 5 that a sales representative may use to determine the financial characteristics of sales that he or she has already made to an account, or to evaluate the financial impact of sales opportunities to an existing or potential account. A computer implemented method of presenting financial characteristics of sales opportunities entered by the user is provided. The sales representative may prefer to evaluate sales opportunities by specifying product and potential revenue. Alternatively, sales representative may prefer to evaluate sales opportunities by specifying product and quantity. Once a sales representative can see the cost and contribution that particular items or accounts have, he or she can then focus on selling the higher-contribution products to maximize the benefit of his or her sales efforts.

### CROSS REFERENCE TO RELATED APPLICATIONS

Priority under 35 U.S.C. § 119 is claimed based on U.S. Provisional Application No. 60/496,643, filed Aug. 20, 2003, the disclosure of which is expressly incorporated herein by reference.

### BACKGROUND

### Technical Field

Embodiments disclosed herein relate to methods and apparatus to assist a sales organization in understanding the financial impact that sales that its members have made or may make has on the bottom line of a business. Specifically, the field relates to electronic pre-programmed user-interactive spreadsheets and methods of using them to present the financial impact of specific sales.

Sales representatives of organizations sell products or services to customers. Each customer may be given an account name or number and records may be kept as to the products or services that each account typically purchases. The revenue that an item, whether a product or a service, generates for a business may not match the financial benefit that a company derives from selling that item. Each product or service has a unit cost. The portion of the revenue that exceeds the unit cost is accounted as profit or, in other words, the contribution that it makes toward the bottom line. Sales representatives make decisions about which items to encourage their accounts to buy. Equipping sales representatives with a tool to evaluate the contribution to each account made by the sales, or even by each product, can assist sales representatives in focusing their efforts on the higher-contribution accounts and products and in devising sales strategies that will maximize contribution for a company.

For companies that have relatively stable unit cost and price structures, the cost and contribution portion of the revenue generated by each item sold may be known with confidence, such that emphasis on future sales may be based on that data. However, sales representatives may not have easy access to the unit cost and unit contribution of each product. Even if they do have access to the unit cost and unit contribution of each product that they sell, they must work either work with a calculator and paper or a spreadsheet in order to calculate the overall contribution of a particular account and to determine the contribution that each sale may make. When traveling, as many sales representatives do, keeping these calculation resources readily available may not be convenient. Thus sales representatives may focus their efforts on sales that bring in the greatest revenue, but not necessarily those sales which would bring in the greatest contribution.

A convenient tool to assist in planning sales efforts that will have the greatest positive impact on an organization's bottom line is needed. In particular, sales representatives of the United States Postal Service (“USPS”) including Area Sales Managers, National Account Managers, and Account Representatives are in need of such a tool with which to plan sales strategies.

### SUMMARY

In one aspect, a computer implemented method of presenting to a user financial characteristics of sales, comprises displaying to a user a list of items for sale, receiving from a user a selection of a first item from the list, retrieving at least one of cost and revenue data for the first user-selected item, receiving from the user a first quantity, wherein the first quantity is a quantity of the first user-selected item, calculating a plurality of financial characteristics of a first sales opportunity, wherein the first sales opportunity comprises selling the first quantity of the first user-selected item, and displaying for simultaneous viewing by the user the first user-selected item, the first quantity, and at least one of the plurality of financial characteristics of the first sales opportunity.

In another aspect, a computer implemented method of presenting financial characteristics of sales, comprising: displaying to the user a list of items for sale; receiving from the user a selection of a first item from the list; retrieving at least one of cost and revenue data for the first user-selected item; receiving from the user a potential revenue generated by a first sales opportunity, wherein the first sales opportunity comprises a sale of a quantity of the first user-selected item that generates the potential revenue; calculating a plurality of financial characteristics of the first sales opportunity; and displaying for simultaneous viewing by the user the first user-selected item, the potential revenue, and at least one of the plurality of financial results of the first sales opportunity.

In yet another aspect, a computer readable medium containing instructions for controlling a data processing system to perform a method of presenting financial characteristics of hypothetical or existing sales of products or services, the method comprising: displaying to a user a list of items for sale; receiving from a user a selection of a first item from the list; retrieving at least one of cost and revenue data for the first user-selected item; receiving from the user a first quantity, wherein the first quantity is a quantity of the first user-selected item; calculating a plurality of financial characteristics of a first sales opportunity, wherein the first sales opportunity comprises selling the first quantity of the first user-selected item; and displaying for simultaneous viewing by the user the first user-selected item, the first quantity, and at least one of the plurality of financial characteristics.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments consistent with the invention and together with the description, serve to explain the principles of the invention. In the drawings,

FIG. 1a is a diagram of a network system consistent with the present invention;

FIG. 1b is a diagram of a stand alone system consistent with the present invention;

FIG. 2 shows a “CRA Detail Summary” sheet used in the system of FIG. 1a or FIG. 1b;

FIG. 3 shows a “home” sheet used in the system of FIG. 1a;

FIG. 4 shows an “instructions” sheet used in the system of FIG. 1a or FIG. 1b;

FIG. 5 shows a portion of a “Calculator Revenue” sheet used in the system of FIG. 1a or FIG. 1b;

FIG. 6 shows a portion of the “Lookup Revenue” sheet used in the system of FIG. 1a or FIG. 1b that provides the data of the CRA for each of the user-selected products displayed on the “Calculator Revenue” sheet of FIG. 5;

FIG. 7 shows another portion of the “Calculator Revenue” sheet used in the system of FIG. 1a or FIG. 1b;

FIG. 8 shows a portion of a “Calculation by Pieces” sheet used in the system of FIG. 1a or FIG. 1b;

FIG. 9 shows a portion of a “Lookup Pieces” sheet used in the system of FIG. 1a or FIG. 1b that provides the data of the CRA for each of the user-selected products displayed on the “Calculation by Pieces” sheet of FIG. 8;

FIG. 10 shows an “RMC” sheet used in the system of FIG. 1a or FIG. 1b that provides at least a graphical representation of the potential revenue, marginal cost, and contribution calculated on the Calculator Revenue sheet of FIG. 5 for each of the user-selected products; and

FIG. 11 shows a “Pieces” sheet used in the system of FIG. 1a or FIG. 1b that provides at least a graphical representation of the potential revenue, marginal cost, and contribution calculated on the Calculation by Pieces sheet of FIG. 8 for each of the user-selected products.

### DESCRIPTION OF EMBODIMENTS

Reference will now be made in detail to the exemplary embodiments consistent with the invention, examples of which are illustrated in the accompanying drawings. Wherever possible, the same reference numbers will be used throughout the drawings to refer to the same or like parts. In the figures, example dollar values have been inserted for purposes of description only. The dollar values do not represent actual cost or revenue data.

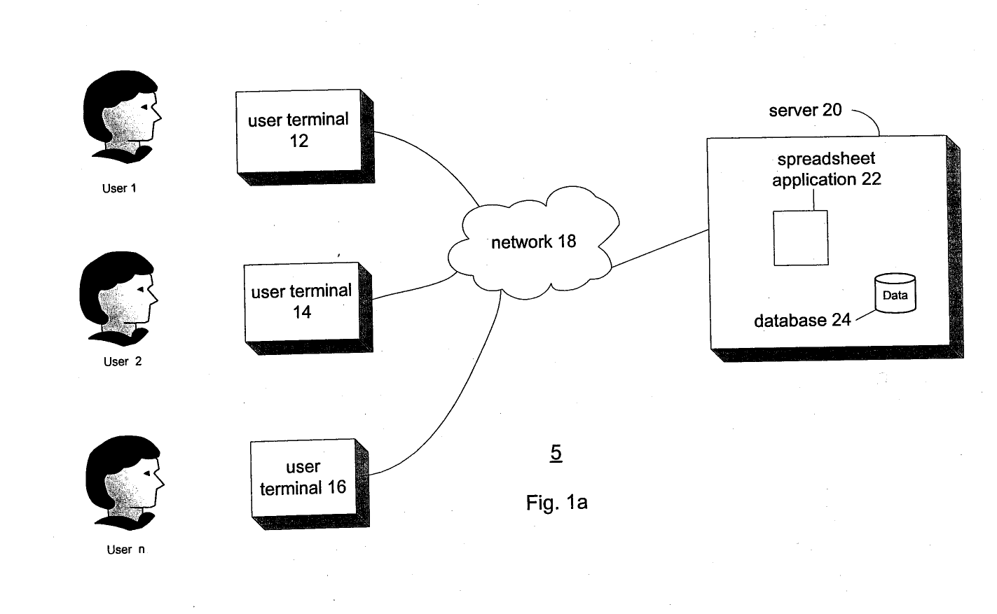

FIG. 1a shows a system 5 consistent with the present invention. A plurality of user terminals 12, 14, and 16 are coupled to a network 18. At least one server 20 is also coupled to network 18. Server 20 comprises a worksheet application 22 and a database 24 of cost and revenue data on currently sold products. Database 24 may also be stored within the worksheet application or external to server 20. Thus a user may access worksheet application 22 on server 20 through network 18 and enter inputs and observe displays at a user terminal 12, 14, or 16. A plurality of users may access worksheet application 22 simultaneously in this manner.

FIG. 1b shows an alternate system 6 consistent with the present invention. Application 22 and database 24 may be stored on a computer readable medium 17, to enable a sales representative to use application 22 and database 24 even when he or she does not have network access. Computer readable medium 17 may be a removable and portable medium, such as, for example, a memory stick, diskette, or CD ROM, or it may be permanent memory such as, for example, a hard drive. A user may insert a removable and portable computer readable medium 17 into a corresponding drive or port of a stand alone terminal 13 having a processor 15. Alternatively, processor 15 may access application 22 and database 24 from permanent memory 17 of stand alone terminal 13. Application 22 may then generate at least one of the above described calculator sheets.

Organizations may be required to estimate cost and revenue data at least annually. For example, the USPS prepares an annual Cost and Revenue Analysis (“CRA”) for the time period of October 1 through September 30. The revenue estimates include total revenue for each category of mail or service and the unit revenue for each type of mail or service. The cost estimates include the incremental and marginal costs for each category of mail or service. From this data, an estimate of profits, or contribution, for each category of mail or service, or for each piece of mail or service item may be calculated for that October through September time period.

The Cost and Revenue Analysis (“CRA”) provides estimates of the volume, revenue, and cost structure of each subclass or category of mail delivered by the USPS. As used herein “marginal costs” is the estimate of the change in cost that results from a small change in a mail subclass or categories' volume alone, when the volumes of other subclasses or mail categories remain constant. As used herein, contribution is defined as revenue per piece minus marginal cost per piece. Contribution indicates the rate at which a given subclass offsets all other costs. As used herein, revenue is defined as income received or collected from the sale of all USPS stamp sources and services.

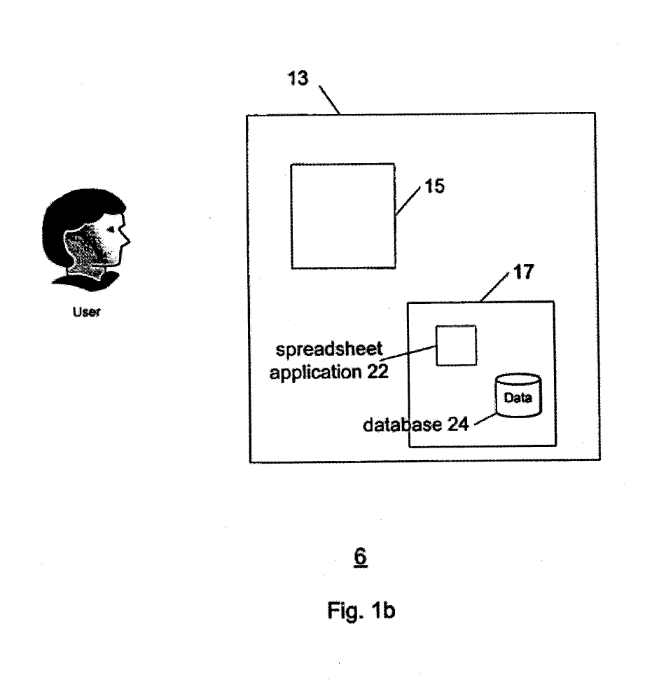

These estimates from the CRA are used in an embodiment consistent with the invention to create the a “CRA Detail Summary” sheet, a partial example of which is as illustrated in FIG. 2. The CRA Detail Summary sheet may be generated by the worksheet spreadsheet application of FIG. 1a, and contains a table consisting of columns A through 1, and 61 rows of data, the first of which, which is the header row. Column A, as here embodied, is entitled “Products” and lists the products sold during the 2002 CRA time period by the USPS. Column B, as here embodied, is entitled “2002 GFY Volumes (in millions)” and lists the estimated volume or, in other words, the quantity of each of the products in column A that were sold during the CRA time period. Column C, as here embodied, is entitled “Total Cost (in $ thousands)” and lists the estimated total cost to sell each of the products listed in column A during the CRA time period. Column D, as here embodied, is entitled “Total Contribution (in $ thousands)” and lists the estimated amount of money that each of the products listed in column A contributed to the bottom line, or in other words profit per type of product sold during the CRA time period. Column E, as here embodied, is entitled “Unit Cost (in $/piece) and lists the estimated cost to sell one piece of mail of the product listed in column A during the CRA time period. Column F, as here embodied, is entitled “Unit Contribution ($/pc)” and lists the estimated amount of money that one piece of mail of the product listed in column A contributed to the bottom line during the CRA time period. Column G, as here embodied, is entitled “Revenue/PC), and lists the revenue that one piece of mail of the product listed in column A generated during the CRA time period. Column H, as here embodied, is entitled “% of Unit Cost ($/pc)” and lists the percentage of Total Revenue that the Total Cost represented during the CRA time period. Column I, as here embodied, is entitled “% of Unit Contribution ($/pc)” and lists the contribution that one piece of mail of the product listed in column A generated during the CRA time period. Sixty products are listed in column A, as here embodied, in rows 2 through 61. The values of the variables just described for each of the products in column A populate the cells in rows 2-61 in each of columns B through I. In this example, however, not all cells have values. Other arrangements of the above described data categories are possible.

Application 22 may be created with a commercial spreadsheet software program, such as Microsoft Excel, to perform the steps of the embodiments described herein. Spreadsheet programs such other than Microsoft Excel, such as Lotus 1-2-3, may also be used. However, application 22 may be executed over the world wide web and written in XML or another appropriate language.

Employees of an organization may access application 22 via user terminals 12, 14, 16 using a browser application, intranet, and knowledge of the URL for the customer connection. If application 22 was created with a commercial spreadsheet software program, the user terminal may include a copy of it in order to open application 22.

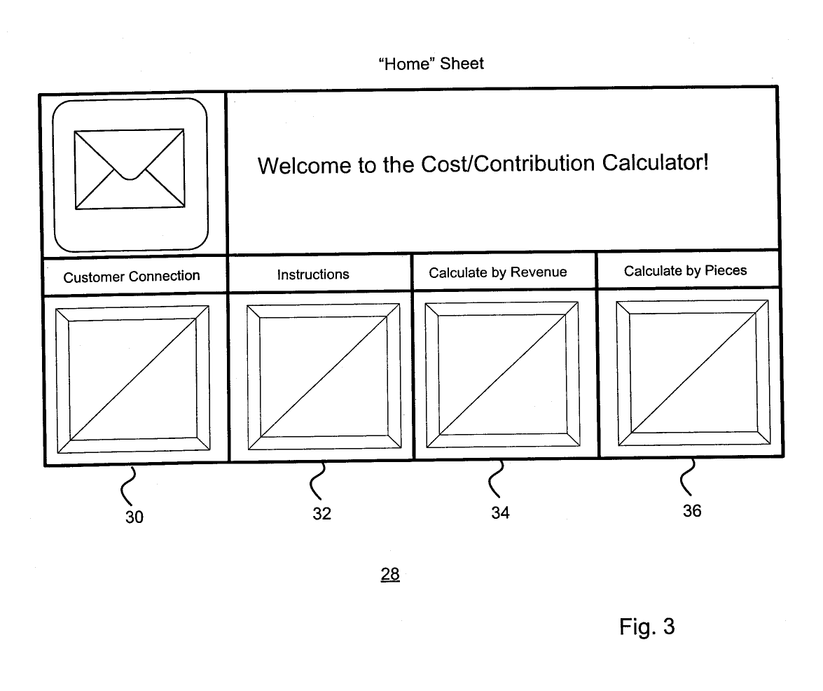

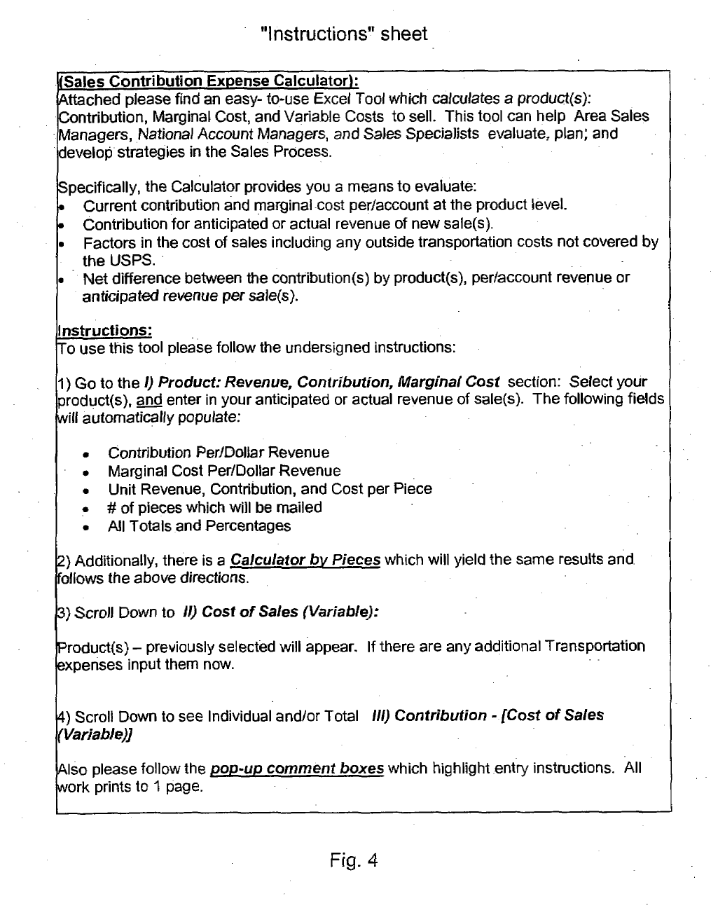

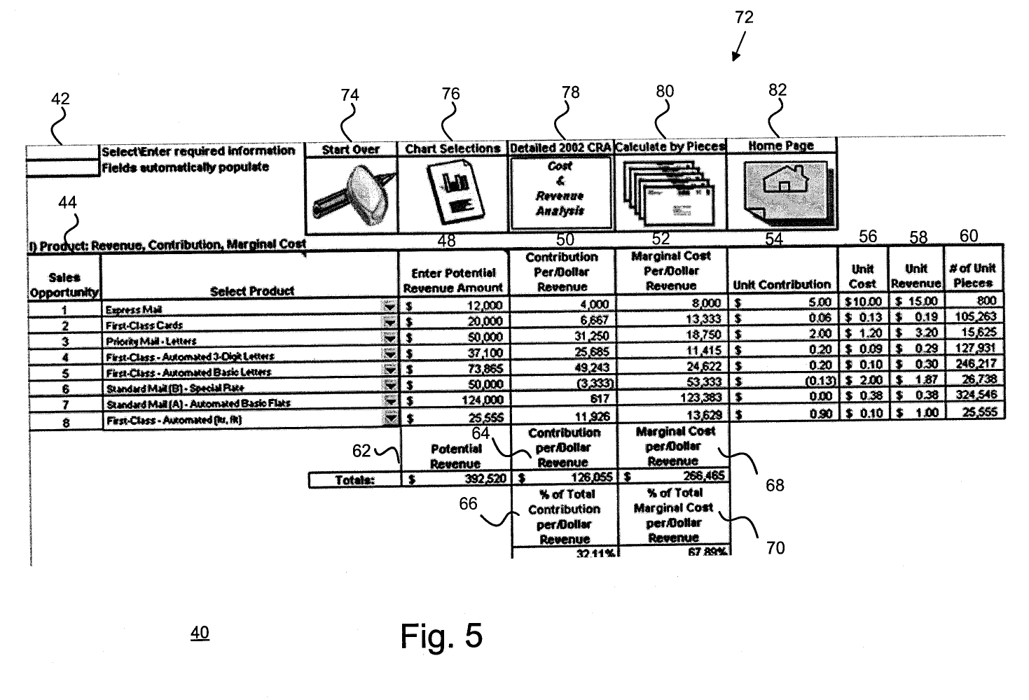

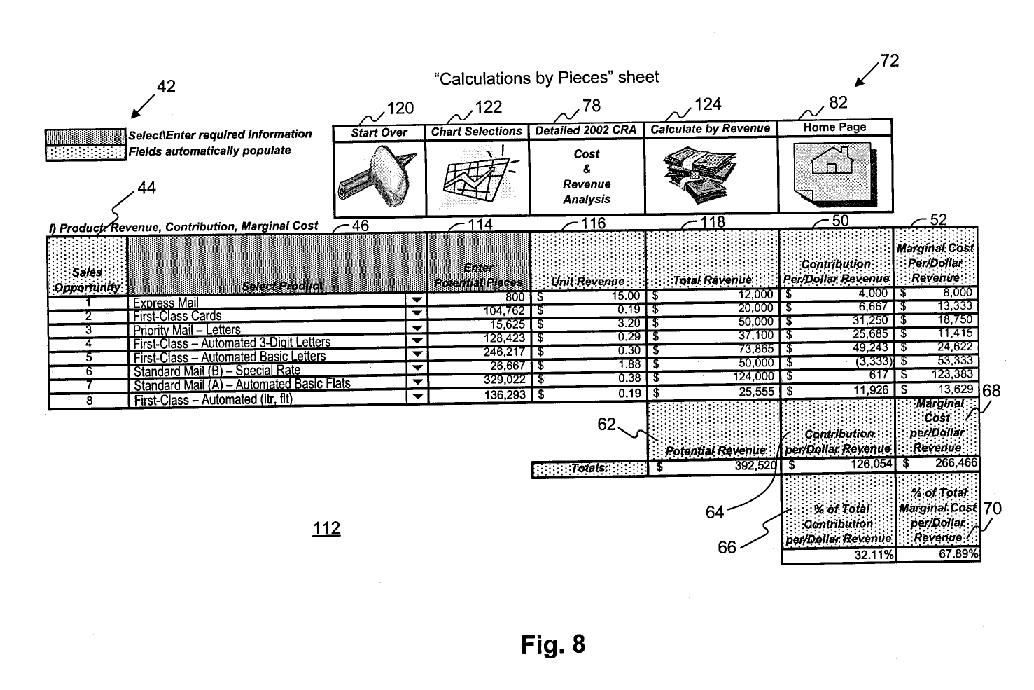

Application 22 creates a plurality of display screens, or “sheets,” which are transmitted to and displayed on user terminal 12-16. First, application 22 creates a “Home” sheet 28, illustrated in FIG. 3 containing four clickable buttons 30-36. As here embodied, button 30 is entitled “customer connection,” and provides a user terminal with access to it. As here embodied, customer connection button 30 will execute a macro to automatically connect user terminal 12 to server 20. As here embodied, button 32 displays an “instructions” sheet 38, shown in FIG. 4, which contains instructions for using calculator sheets accessed by buttons 34 and 36. As here embodied, button 34 provides access to a “Calculator Revenue” sheet 40, shown in FIG. 5, which, as here embodied, allows a user to calculate at least cost and contribution of each of a combination of sales opportunities, specified by product and potential revenue per sale. As here embodied, button 36 provides access to an “Calculation by Pieces” sheet 112, shown in FIG. 8, which, as here embodied, allows a user to calculate at least cost and contribution of a combinations of sales opportunities, specified by product and potential quantity per sale.

Home sheet 28 of FIG. 3 is not required. However, it enables users to conveniently locate the most used sheets of Cost/Contribution Calculator application 22 and access the main sales organization page, “Customer Connection.”

Instruction sheet 38, FIG. 3, may list the financial or other characteristics which application 22 will determine for each entered sales opportunity. Instruction sheet 38 may list those particular types of organization employees that application 22 is most likely to assist. Specifically, as here embodied, instruction sheet 38 lists contribution, marginal cost, and variable costs for each sales opportunity or combination of sales opportunities. It may, of course, list whatever relevant variable may be calculated and or displayed in another embodiment. Additionally, as here embodied, the instructions sheet 38 provides instructions for use of application 22 by inputting a product and potential revenue of the sales opportunity, as well as by inputting a product and expected quantity of the sales opportunity. It also, as here embodied, provides instructions that additional variable costs, such as additional transportation expenses, for example, may be included in the cost and contribution calculation if relevant. Lastly, as here embodied, it informs the user of helpful pop-up comment boxes that “highlight entry instructions.”

As here embodied, worksheet spreadsheet application 22 generates a “Calculator Revenue” sheet 40, FIG. 5, which will be displayed on user terminal 12, 14, or 16 when a user clicks on link 34 of the Home sheet (FIG. 3). Only a portion of Calculator Revenue sheet 40 is illustrated in FIG. 5. Calculator Revenue sheet 40, as here embodied, has a legend 42, which informs a user that spreadsheet columns whose heading cells are in a dark color require the user to select something or enter something into their cells. Legend 42 also informs a user that columns whose heading cells are in a light color will automatically produce appropriate values within those cells, based on data pre-stored in database 24, such that values of all cells are displayed to the user and may be viewed at the same time.

Calculator Revenue sheet 40, as here embodied, contains a block of cells comprising nine columns 44, 46, 48, 50, 52, 54, 56, 58, and 60, each containing a plurality of rows beneath the header row. Columns 48, 50 and 52, as here embodied, each contain additional rows that provide further calculations based on the inputs of the cells above them.

Column 44, as here embodied, has a header cell entitled “Sales Opportunity,” with eight cells beneath listing the numbers 1 though 8. The number of cells in column 44 (and corresponding sales opportunity numbers) may be any convenient number is preferred by the particular sales force using the application. For example, if twenty different products are typically sold to each account, then it would be appropriate to have twenty sales opportunities for sales representatives to input and of which to evaluate the effects. Column 44 is preferred, but not required, as it provides an additional method of keeping track of how many sales opportunities a user is evaluating.

Column 46, as here embodied, has a header cell entitled “Select Product.” The header cell of column 46 may also have a pop-up comment window (not shown) that appears on user terminal screen when a user rests the pointer of a mouse on top of the header cell of column 46. As here embodied, the column 46 pop-up comment window displays the following text: “Use the Drop Window to select a product from the list below.” As here embodied, in each of the eight cells below the header cell of column 46, a downward pointing arrow 47 appears on the right-hand side of the cell, indicating that the cell is configured with a drop-down menu. By clicking on arrow 47, a drop-down menu may appear. As here embodied, the drop-down menu displays a list of n total mail products or services. The list of items may, of course, include products or services of any company. A slider bar on the right of the list (not shown) may allow a user to scroll between the beginning of the list and the end of the list.

When a user clicks on a item in the drop-down menu, application 22 receives the user's selection of the item from the list. The drop-down menu then disappears and the user-selected item is displayed in the cell of column 46.

In the example of FIG. 5, the first user-selected item displayed on the computer screen is the product Express Mail™ overnight letters; the second user-selected product is First-Class™ Cards; the third user-selected product is Priority Mail™—Letters; the fourth user-selected product is First-Class™—Automated 3-Digit Letters; the fifth user-selected product is First-Class™—Automated Basic Letters; the sixth user-selected product is Standard Mail™ (B)—Special Rate; the seventh user-selected product is Standard Mail™ (A)—Automated Basic Flats; and the eighth user-selected product is First-Class™—Automated (Itr, fit). Each of these user-selected products represents the product of the corresponding sales opportunity of column 44.

Column 48, as here embodied, has a header cell entitled “Enter Potential Revenue Amount.” The header cell of column 48 may also have a pop-up comment window (not shown) that application 22 displays to the user when a user rests the pointer of the mouse on top of the cell. As here embodied, the column 48 pop-up comment window displays the following text: “Type in your anticipated Revenue for a Sale.”

Each of the eight cells below the header cell of column 48 may have a number entered by the user representing the expected, anticipated, potential, or actual revenue generated by a sale of a certain number of the corresponding user-selected item from column 46 within it. As here embodied, the number is depicted in U.S. dollars by the presence of the dollar sign on the left edge of the cell. In the example of FIG. 5, the first user-entered revenue of a sale of the first user-selected product (the first sales opportunity) Express Mail™ is $12,000; the second user-entered revenue of a sale of the second user-selected product (the second sales opportunity) First-Class™ Cards is $20,000; the third user-entered revenue of a sale of the third user-selected product (the third sales opportunity) Priority Mail™—Letters is $50,000; the fourth user-entered revenue of a sale of the fourth user-selected product (the fourth sales opportunity) First-Class™—Automated 3-Digit Letters is $37,100; the fifth user-entered revenue of a sale of the fifth user-selected product (the fifth sales opportunity) First-Class™—Automated Basic Letters is $73,865; the sixth user-entered revenue of a sale of the sixth user-selected product (the sixth sales opportunity) Standard Mail™ (B)—Special Rate is $50,000; the seventh user-entered revenue of a sale of the seventh user-selected product (the seventh sales opportunity) Standard Mail™ (A)—Automated Basic Flats is $124,000; and the eighth user-entered revenue of a sale of the eighth user-selected product (the eighth sales opportunity) First-Class™—Automated (Itr, fit) is $25,555. Alternatively, the potential revenue could be displayed as a list of possible revenues in a drop-down menu and the user could select a potential revenue from the list in a manner similar to the method of selecting products in column 44.

Columns 50-58 display financial characteristics or, in other words, potential financial results of the anticipated sale. Column 50, as here embodied, has a header cell entitled “Contribution Per/Dollar Revenue.” The eight cells below the header cell of column 50 each display a value calculated by a pre-programmed formula of application 22 that, as here embodied, multiplies the value in the cell of a corresponding row in column 48 by a value from database 24 that specifies the contribution per dollar of revenue for the specific product selected by the user. The eight cells below the header cell of column 50 may display a financial characteristic or result of the specified sales opportunity: dollars of contribution that will results from dollars of the anticipated revenue entered in column 48.

In the example of FIG. 5, the contribution of the first sales opportunity is $4,000; the contribution of the second sales opportunity is $6,667; the contribution of the third sales opportunity is $31,250; the contribution of the fourth sales opportunity is $25,756 the contribution of the fifth sales opportunity is $25,685; the contribution of the sixth sales opportunity is negative $3,333; the contribution of the seventh sales opportunity is $617; and the contribution of the eighth sales opportunity is $11,926.

Column 52, as here embodied, has a header cell entitled “Marginal Cost Per/Dollar Revenue.” The eight cells below the header cell of column 52 each display a value calculated by a pre-programmed formula of application 22 that, as here embodied, multiplies the value in the cell of a corresponding row in column 48 by a value from database 24 that specifies the marginal cost per dollar of revenue for the specific product selected by the user. The eight cells below the header cell of column 52 may display a financial characteristic or result of the specified sales opportunity: dollars of the anticipated revenue entered in column 48 that will have been spent to sell the product. In the example of FIG. 5, the marginal cost of the first sales opportunity is $8,000; the marginal cost of the second sales opportunity is $13,333; the marginal cost of the third sales opportunity is $18,750; the marginal cost of the fourth sales opportunity is $11,415; the marginal cost of the fifth sales opportunity is $24,622; the marginal cost of the sixth sales opportunity is $53,333; the marginal cost of the seventh sales opportunity is $123,383; and the marginal cost of the eighth sales opportunity is $13,629.

Column 54, as here embodied, has a header cell entitled “Unit Contribution.” Each of the eight cells below the header cell of column 54 displays a value from database 24 that specifies the unit contribution as calculated from the most recent Cost and Revenue Analysis Report. In the example of FIG. 5, the unit contribution of the first user-selected product is $5.00; the unit contribution of the second user-selected product is $0.06; the unit contribution of the third user-selected product is $2.00; the unit contribution of the fourth user selected product is $0.20; the unit contribution of the fifth user-selected product is $0.20; the unit contribution of the sixth user-selected product is negative $0.13; the unit contribution of the seventh user-selected product is $0.00; the unit contribution of the eighth user-selected product is $0.09.

Column 56, as here embodied, has a header cell entitled “Unit Cost.” Each of the eight cells below the header cell of column 56 displays a value from database 24 that specifies the unit cost as calculated from the most recent Cost and Revenue Analysis Report. In the example of FIG. 5, the unit cost of the first sales opportunity (first user-selected product) is $10.00; the unit cost of the second sales opportunity (second user-selected product) is $0.13; the unit cost of the third sales opportunity (third user-selected product) is $1.20; the unit cost of the fourth sales opportunity (fourth user-selected product) is $0.09; the unit cost of the fifth sales, opportunity (fifth user-selected product) is $0.10; the unit cost of the sixth sales opportunity (sixth user-selected product) is $2.00; the unit cost of the seventh sales opportunity (seventh user-selected product) is $0.38; and the unit cost of the eighth sales opportunity (eighth user-selected product) is $0.10.

Column 58, as here embodied, has a header cell entitled “Unit Revenue.” Each of the eight cells below the header cell of column 58 displays a value calculated by a pre-programmed formula of application 22 that, as here embodied, adds the values of the corresponding cells in column 54 (Unit Cost) and column 56 (Unit Contribution). in the example of FIG. 5, the unit revenue of the first sales opportunity (first user-selected product) is $15.00; the unit revenue of the second sales opportunity (second user-selected product) is $0.19; the unit revenue of the third sales opportunity (third user-selected product) is $3.20; the unit revenue of the fourth sales opportunity (fourth user-selected product) is $0.29; the unit revenue of the fifth sales opportunity (fifth user-selected product) is $0.30; the unit revenue of the sixth sales opportunity (sixth user-selected product) is $1.88; the unit revenue of the seventh sales opportunity (seventh user-selected product) is $0.38; and the unit revenue of the eighth sales opportunity (eighth user-selected product) is $0.19.

Column 60, as here embodied, has a header cell entitled “# of Unit Pieces.” Each of the eight cells below the header cell of column 60 displays a value calculated by a pre-programmed formula of application 22 that, as here embodied, divides the user-entered revenue by the unit revenue and displays the nearest whole number, which represents the approximate number of pieces of mail of the user-selected product that would need to be sold to generate the user-entered revenue for that sales opportunity. In the example of FIG. 5, the number of pieces of the first sales opportunity (first user-selected product) is 800; the number of pieces of the second sales opportunity (second user-selected product) is 104,762; the number of pieces of the third sales opportunity (third user-selected product) is 15,625; the number of pieces of the fourth sales opportunity (fourth user-selected product) is 128,423; the number of pieces of the fifth sales opportunity (fifth user-selected product) is 246,217; the number of pieces of the sixth sales opportunity (sixth user-selected product) is 26,667; the number of pieces of the seventh sales opportunity (seventh user-selected product) is 329,002; and the number of pieces of the eighth sales opportunity (eighth user-selected product) is 136,293.

Column 48, as here embodied, has a header cell 62 following the eight cells displaying the user-entered revenue. Header cell 62, as here embodied, is entitled “Potential Revenue.” The cell below it may display the sum of the eight cells above header cell 62. In the example of FIG. 5, the total potential revenue is $392,520.

Column 50, as here embodied, has two additional header cells 64 and 66. Header cell 64, as here embodied, is entitled “Contribution per/Dollar Revenue.” The cell below header cell 64 displays the sum of the eight cells above header cell 64. In the example of FIG. 5, the total contribution of the eight sales opportunities is $126,054. Header cell 66, as here embodied, is entitled, “% of Total Contribution per/Dollar Revenue.” The cell below header cell 66 displays the percentage that the total contribution in dollars of the eight cells as displayed in the cell below header cell 64 represents of the total potential revenue as displayed in the cell below header cell 62 in column 48. In the example of FIG. 5, the percentage of the total potential revenue that the total contribution represents is 32.11%.

Column 52, as here embodied, has two additional header cells 68 and 70. Header cell 68, as here embodied, is entitled “Marginal Cost per/Dollar Revenue.” The cell below header cell 68 displays the sum of the eight cells above header cell 68, or, in other words, the total marginal cost of the eight sales opportunities. In the example of FIG. 5, the total marginal cost is $266,466. Header cell 70, as here embodied, is entitled “% of Total Marginal Cost per/Dollar Revenue.” The cell below header cell displays the percentage of the total potential revenue that the total marginal cost represents. In the example of FIG. 5, the percentage of total potential revenue that the total marginal cost represents is 67.89%.

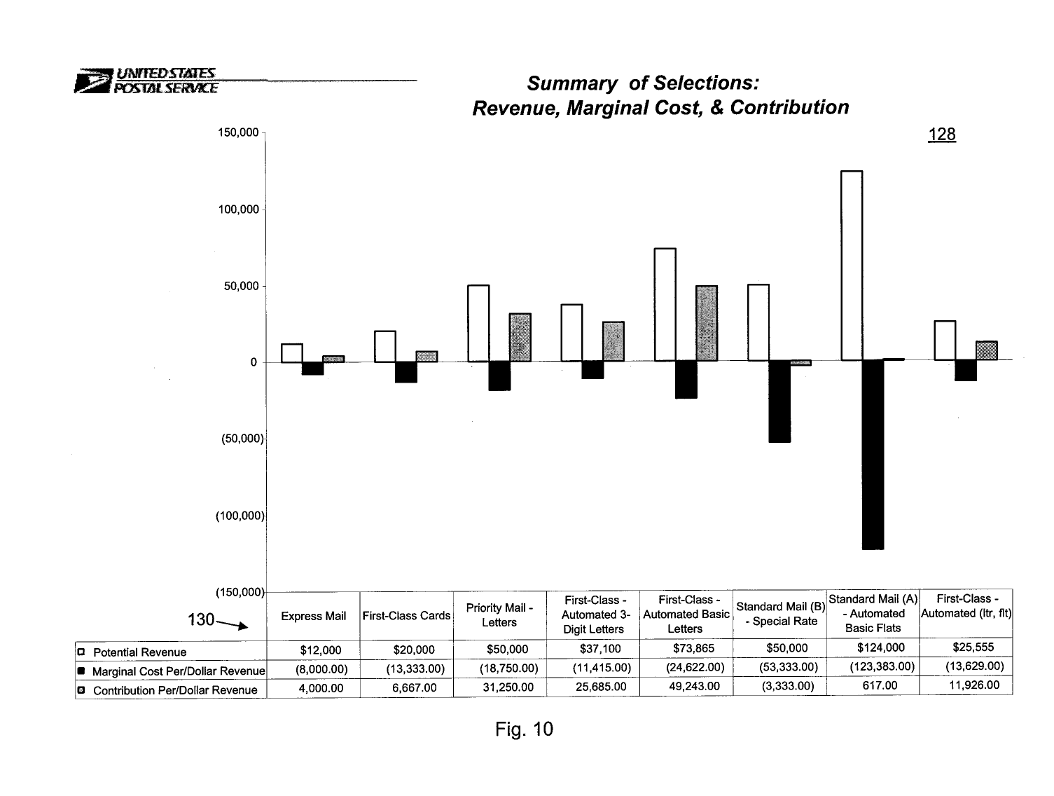

Calculator Revenue sheet 40 of FIG. 5, as here embodied, also has a strip 72 that contains five clickable buttons, which either perform macros when clicked or direct the user to another sheet of the worksheet. Button 74, here entitled, “Start Over,” performs a macro. The macro clears the user's product selections of column 46 and the user's entries of column 48. Button 76, here entitled “Chart Selections” is a link that directs a user to an “RMC” (Revenue, Marginal Cost and Contribution) sheet, an embodiment of which is illustrated in FIG. 10. Button 78, here entitled “Detailed 2002 CRA” is a link that directs the user to the “CRA Detailed Summary” sheet 26, which contains all entries of database 24. Button 80, here entitled “Calculate by Pieces” is a link that directs the user to, “Calculation by Pieces” sheet, an embodiment of which is illustrated in FIG. 8. Button 82, here entitled “Home Page” is a link that returns the user to “Home” sheet 28 (FIG. 3) when the user clicks on it.

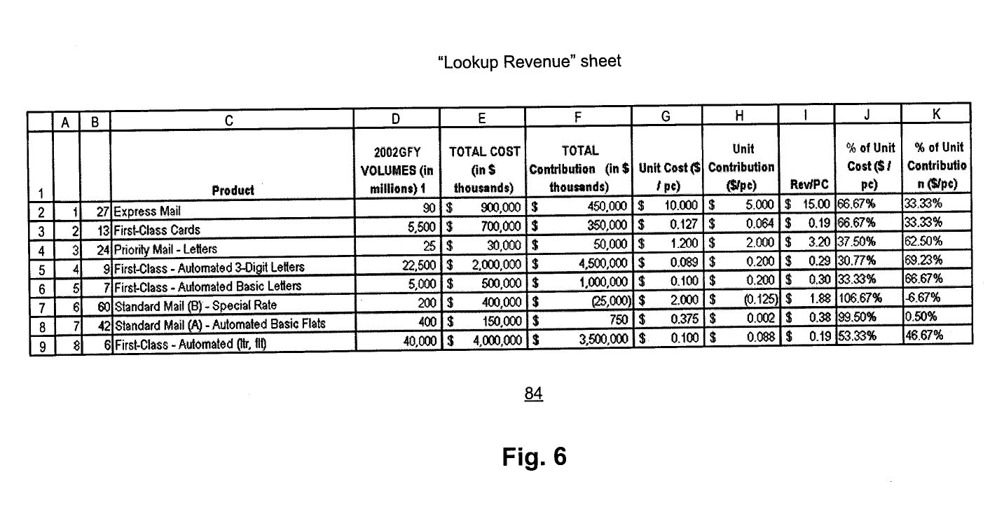

FIG. 6 illustrates the portion of “Lookup Revenue” sheet 84 generated by application 22 and displayed on user terminal 12, which, as here embodied, contains the cells displaying database values used by application 22 to calculate values of certain cells in “Calculator Revenue” sheet 40 (FIG. 5). As here embodied, the portion set forth in FIG. 6 contains eleven columns A through K and nine rows, the first of which is the header row. Column A, as here embodied, contains the same numbers as Column 44 of FIG. 5, and these correspond to the same sales opportunities. Column B, as here embodied, contains the number from a list of the products offered for sale. Because the 2002 Detail Summary of the CRA lists n products, the numbers in column B, as here embodied, will be between 1 and n. The number corresponds to the position of the user-selected product within the list in the drop down menu in column 46 of FIG. 5. Column C, as here embodied, has a header cell entitled “Product” and the eight cells below the header row match the user-selected products of column 46 of FIG. 5. The two sheets may be programmed to automatically copy the product name from the database 24 values displayed in the CRA Detail Summary sheet 28 (FIG. 2) which, as here embodied, exists below the illustrated portion of “Lookup Revenue” Sheet 84. In this embodiment, the rows of the next eight columns, Columns D through K, are copies of the header row of the CRA Detail Summary sheet 26 and the relevant data from the CRA Detail Summary for each of the user-selected products listed in Column C.

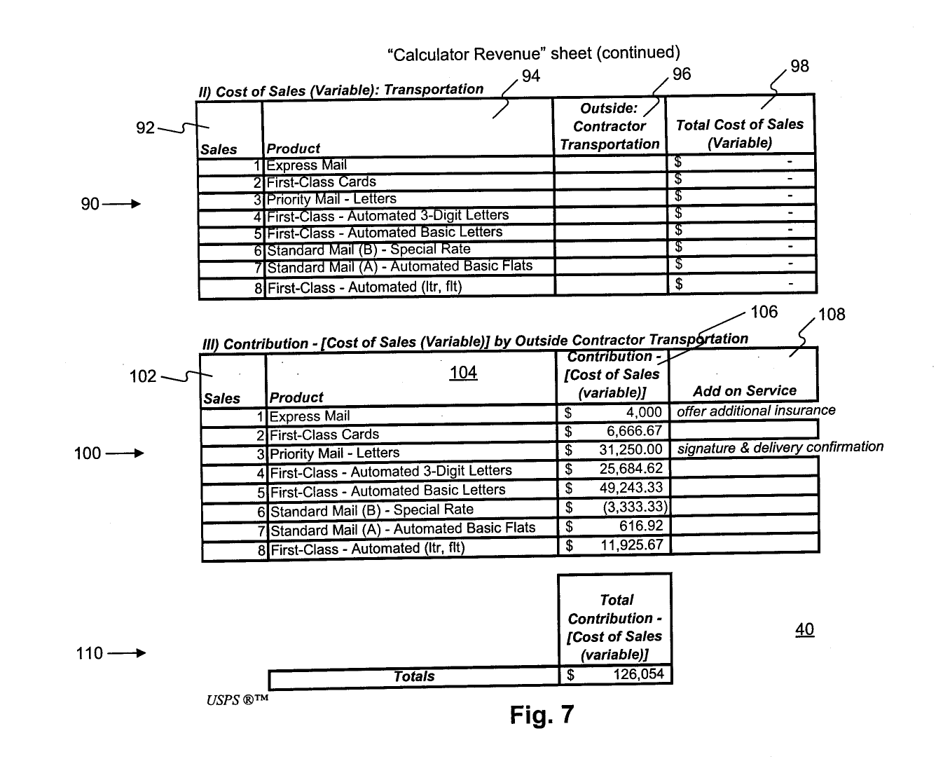

FIG. 7 illustrates another portion of “Calculator Revenue” sheet 40, as here embodied. This portion, as here embodied, consists of three blocks of cells 90, 100, and 110. Block 90 labeled “II) Cost of Sales (Variable): Transportation” may allow a user to calculate the total costs of sales including new costs for a particular sale, including, for example, the cost of outside contractor transportation. As here embodied, block 90 consists of four columns 92, 94, 96, and 98. As here embodied, column 92 lists the number of the sales opportunity. As here embodied, column 94 lists the user-selected products of each sales opportunity. As here embodied, column 96 is for user entry of the additional costs. Because the header cell of column 96 is in the darker color, according to the legend on the Calculator Revenue sheet (FIG. 5), cells of column 96 require user entries, specifically, the cost of the outside contractor transportation or other new, previously unaccounted for cost. As here embodied, column 98 from the left, labeled “Total Cost of Sales (Variable),” adds the user-entered cost from the cell in column 96 to the Marginal Cost from the portion of “Calculator Revenue” sheet described above for that particular sales opportunity, and displays the new cost value in dollars in the cells of column 98.

The second block of cells 100, as here embodied, is labeled with “III) Contribution—[Cost of Sales (Variable) by Outside Contractor Transportation]”. Block 100 allows the user to see the contribution to the bottom line that these particular sales will make. As with block 90, block 100 may also have four columns. As here embodied, columns 102 and 104 match the contents of block 90's column 92 and 94. As here embodied, column 106 is entitled “Contribution—[Cost of Sales (variable)].” As here embodied, the cells in column 106 display the contribution of the sales opportunities in dollars, based on the total cost of each sale as calculated above in the first block. Column 108, as here embodied, is entitled “Add on Service.” The cells of column 108 may display additional, optional services tied to the products selected by the user and populate with information for up-selling once a product is selected. In the example of FIG. 7, the cell corresponding to sales opportunity number 1 displays “offer additional insurance,” and the cell corresponding to sales opportunity number 3 displays “signature & delivery confirmation.”

As here embodied, block 110 consists of three cells. There are two header cells, one for the column, and one for the row. The header cell for the row, as here embodied, is entitled “Totals.” The header cell for the column, as here embodied, is entitled “Total Contribution—[Cost of Sales (variable)].” The cell of that column and row displays the sum of the contributions of each individual sales opportunity listed in column 108 of block 100. This reflects the contribution that these sales opportunities will create given the additional costs listed in column 96 of block 90.

FIG. 8 illustrates an embodiment consistent with the invention that allows users to calculate the financial impact of sales by the number of pieces of mail rather than by revenue. Here, a “Calculation by Pieces” sheet 112 may include a legend 42, identical to “Calculator Revenue” sheet 40 in FIG. 5. Calculation by Pieces sheet 112 may also have a column 44 for the number of the sales opportunity, and column 46 with drop down menus for user selection of products sold by the USPS.

Column 114, as here embodied, is entitled “Enter Potential Pieces” in the header cell. It has a pop-up comment window (not shown) that will display the following text when a user rests the pointer of the mouse over the header cell: “Type in your anticipated # of pieces.” Each of the eight cells below the header cell contain the user-entered number of the product listed in cell to the left in column 46 that the user anticipates selling or has sold. In the example of FIG. 8, the first user-entered number is 800; the second user-entered number is 104,762; the third user-entered number is 15,762; the fourth user-entered number is 128,423; the fifth user-entered number is 246,217; the sixth user-entered number is 26,667; the seventh user-entered number is 329,022; and the eighth user-entered number is 136,293.

Column 116, as here embodied, has a header cell entitled “Unit Revenue.” Unlike the similarly entitled column 58 of FIG. 5, however, each of the eight cells below the header cell of column 116 display a value from database 24 that specifies the unit revenue of the user-selected product. As here embodied, the values of the unit revenue displayed in column 116 match the values displayed in column 58 of FIG. 5.

Columns 118, 50, and 52 each display financial characteristics of the sale opportunities. Column 118, as here embodied, has a header cell entitled “Total Revenue.” Each of the eight cells below the header cell displays a value calculated by a pre-programmed formula of application 22 that, as here embodied, multiplies the number of the corresponding cell in column 114 by the unit revenue in the corresponding cell in column 116, or in other words, the total revenue that a sale of the user-entered number of the user-selected product will generate. In this embodiment, the values displayed in column 118 match the values of the user-entered revenues of column 48 in FIG. 5.

Additionally, as here embodied, column 118 has a second header cell 160. Header cell 160, as here embodied, is entitled “Potential Revenue.” The cell below header cell 160 may display the sum of the values of the total revenues in each of the eight cells above header cell 160. In the example of FIG. 8, the value displayed in this cell is $392,520.

“Calculation by Pieces” sheet 112 may also include columns 50, “Contribution per/Dollar Revenue” and 52, “Marginal Cost per/Dollar Revenue” as previously described, including the additional cells 64-70 labeling and displaying the total contribution from the sale of the user-entered number of pieces of the user-selected products in both dollars and as a percentage of the total potential revenue and the additional cells labeling and displaying the total marginal cost from the same sale in both dollars and as a percentage.

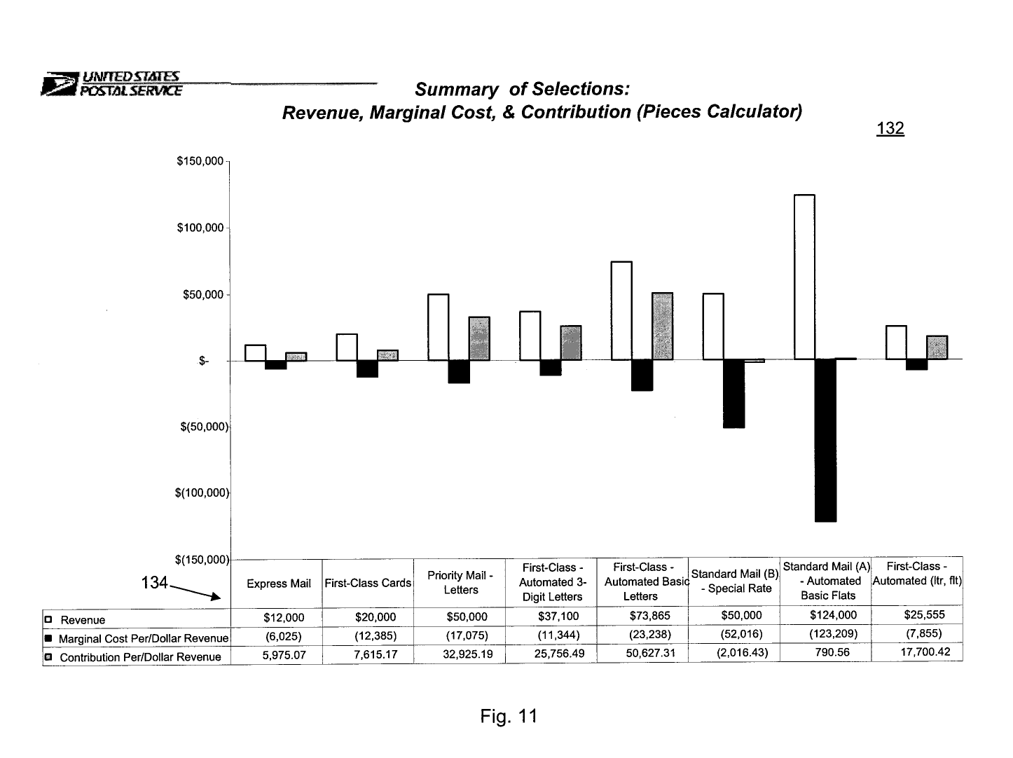

“Calculation by Pieces” sheet 112 may also have a strip of buttons 72, similar to strip 72 of FIG. 5. Button 120, as here embodied, is entitled “Start Over” and clears the user's selection of products and the user's entered number of pieces in columns 46 and 114, when it is clicked. Button 122, as here embodied, is entitled “Chart Selections” and when it is clicked directs the user to the “Pieces” sheet 132, an embodiment of which is illustrated in FIG. 11. Button 78 may be the same as previously described. Button 124, as here embodied, is entitled “Calculate by Revenue” and when clicked, directs a user to “Calculator Revenue” sheet 40 as previously described. Button 82 may be the same as previously described.

“Calculation by Pieces” sheet 112 may also have three additional blocks of cells (90, 100, and 110) (not shown) like those previously described for a portion of the “Calculator Revenue” sheet illustrated in FIG. 7. In this portion of “Calculation by Pieces” sheet 112, a user may calculate the effect of additional costs on the contribution of a sales opportunity requiring the additional costs.

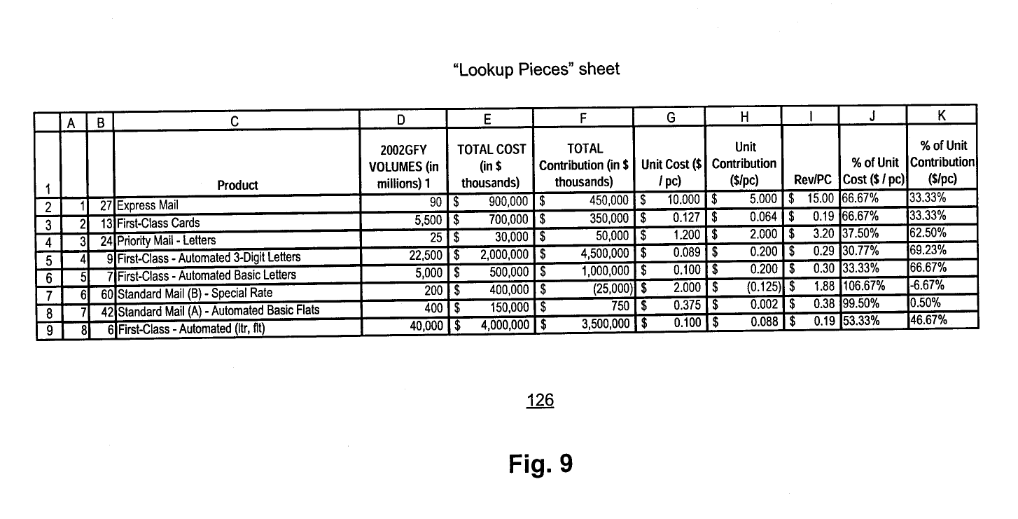

FIG. 9 illustrates a portion of the “Lookup Pieces” sheet 126, which displays data from database 24 and which his the source of values provided, above described cells of “Calculation by Pieces” sheet 112. This portion of “Lookup Pieces” sheet 126, as here embodied, displays the same data as the illustrated portion of “Lookup Revenue” sheet 84 in FIG. 6. However, the products selected from the copy of the CRA, which, as here embodied, is located below the block of cells illustrated, are determined from the products selected by the user in column 46 of “Calculation by Pieces” sheet 112, not column 46 of “Calculator Revenue” sheet 40. The products selected are the same in each for the purposes of ease in explanation only.

An “RMC” Sheet 128 of USPS Cost/Contribution Calculator application 22 is illustrated in FIG. 10. This is the sheet to which users are directed to when they click on button 76 on Calculator Revenue sheet 40, as here embodied. RMC sheet 128, as here embodied, has a title of “Summary of Selections: Revenue, Marginal Cost, & Contribution.” Sheet 128 includes a table 130 containing various calculated and user-entered values. Sheet 128 also includes a graphical display of the values of table 130. Table 130 may contain the same data as columns 48, 50, and 52 of FIG. 5. However, the results may be displayed in rows rather than columns, in order to illustrate the potential revenue, marginal cost, and contribution achieved by selling the anticipated user-entered revenue of the user-selected products. The user-selected products displayed in column 46 of Calculator Revenue sheet 40 may be listed below the graphical depiction of the financial characteristics of the sale, and above the cells containing the associated values from columns 48, 50, and 52 of Calculator Revenue sheet 40. As here embodied, the light grey bars are the potential revenue, the dark grey bars are the marginal cost, and the white bars are the contribution.

FIG. 11 illustrates a “Pieces” sheet 132, which displays a graphical representation of the financial characteristics of the sale of each user-selected product at the user-entered quantities from “Calculation by Pieces” sheet 112. This is the sheet to which button 122 may direct a user to when it is clicked. “Pieces” sheet 132, as here embodied, bears a title of “Summary of Selections: Revenue, Marginal Cost, & Contribution (Pieces Calculator).” Table 134 is identical to table 130 of FIG. 10, however the values may be copied from “Calculation by Pieces” sheet 112 rather than “Calculator Revenue” sheet 40.

A sales representative may use system 5 to determine the financial characteristics of sales that he or she has already made to an account, or to evaluate the financial impact of sales opportunities to an existing or potential account. The sales representative may prefer to evaluate sales opportunities by specifying product and potential revenue. If so, then “Calculator Revenue” sheet 40, as here embodied, would be the preferred tool. Alternatively, sales representative may prefer to evaluate sales opportunities by specifying product and quantity. If this is the case, then “Calculation by Pieces” sheet 112, as here embodied, would be the preferred tool. Once a sales representative can see the cost and contribution that particular items or accounts have, he or she can then focus on selling the higher-contribution products to maximize the benefit of his or her sales efforts.

Other embodiments consistent with the invention will be apparent to those skilled in the art from consideration of the specification and practice of the invention disclosed herein. It is intended that the specification and examples be considered as exemplary only, with a true scope and spirit of the invention being indicated by the following claims.

1-19. (canceled)

20. A computer implemented method of presenting financial characteristics of sales, comprising:
displaying to the user a list of items for sale;
receiving from the user a selection of a first item from the list;
retrieving at least one of cost and revenue data for the first user-selected item;
receiving from the user a potential revenue generated by a first sales opportunity, wherein the first sales opportunity comprises a sale of a quantity of the first user-selected item that generates the potential revenue;
calculating a plurality of financial characteristics of the first sales opportunity; and
displaying for simultaneous viewing by the user the first user-selected item, the potential revenue, and at least one of the plurality of financial characteristics of the first sales opportunity.

21. The method of claim 20 comprising:
calculating an approximate quantity of the first sales opportunity; and
displaying the first user-selected item, the first user-entered potential revenue of the first user-selected item, the plurality of financial characteristics, and the approximate quantity at the same time.

22. The method of claim 20 wherein the financial characteristics comprise the contribution portion in dollars of the potential revenue of the first sales opportunity.

23. The method of claim 20 wherein the financial characteristics comprise the marginal cost in dollars of the potential revenue of the first sales opportunity.

24. The method of claim 20 wherein the financial characteristics comprise the percent of the potential revenue of the first sales opportunity that the contribution represents.

25. The method of claim 20 wherein the financial characteristics comprise the percent of the potential revenue of the first sales opportunity that the marginal cost represents.

26. The method of claim 20 wherein the cost data retrieved comprises unit cost.

27. The method of claim 20 wherein the cost data retrieved comprises marginal cost per dollar revenue.

28. The method of claim 20 wherein the revenue data retrieved comprises unit revenue.

29. The method of claim 20 wherein the revenue data retrieved comprises contribution per dollar revenue.

30. The method of claim 20 wherein retrieving at least one cost and revenue data comprises:
locating at least one cost and revenue data of the first user-selected item from a stored table of cost and revenue data on all products for sale; and
copying cost and revenue data of the first user-selected item for use in calculating the financial results.

31-38. (canceled)
